(19) United States
(12) Patent Application Publication
(10) Pub. No.: US 2004/0128382 A1
(43) Pub. Date: Jul. 1, 2004

(54) Method and apparatus for adjusting resource availability based on power availability

(76) Inventors: Marion Shimoda, Aloha, OR (US); Thomas Cronin, Hillsboro, OR (US); Rajesh Banginwar, Hillsboro, OR (US); Travis Shultz, Hillsboro, OR (US); Roger Hurwitz, Portland, OR (US)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/334,111

(22) Filed: Dec. 31, 2002

(51) Int. Cl. G06F 15/173

(52) U.S. Cl. 709/225

(57) ABSTRACT

An apparatus and method to determine whether to permit use of a local resource by a remote device via a wireless personal area network based on rules associated with power availability of the local device is described. The apparatus and the method may determine whether to use a remote resource of the remote device via the wireless personal area network based on rules associated with power availability of the local device is described.

### BACKGROUND OF THE INVENTION

The increasing usage of mobile communications and computing devices including cellular telephones, pagers, personal digital assistants (PDA's), laptops, and wearable computers has created a demand for wireless personal area networks (WPAN's). Personal area networks connect mobile devices carried by users to other mobile and stationary devices in their proximity.

The WPAN enables devices to share information and resources. Existing standards based, for example, on Bluetooth technology or on infrared technology enables a user of a device to access, for example, a resource on another device by initiating the requested service.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a simplified block-diagram illustration of a device coupled to a wireless personal area network (WPAN) according to some embodiments of the present invention;

FIG. 2 is an exemplary flowchart diagram of a method for using via a WPAN resources of a remote device by an application on a local device according to some embodiments of the present invention; and

FIG. 3 is a flowchart diagram of a method for managing use of local resources by other devices according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operation herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, lead-only memories (ROM's), compact disc read-only memories (CD-ROM's), random access memories (RAM's), electrically programmable read-only memories (EPROM's), electrically erasable and programmable read only memories (EEPROM's), FLASH memory, magnetic or optical cards, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of embodiments of the invention as described herein.

It should be appreciated that according to some embodiments of the present invention, the method described below, may be implemented in machine-executable instructions. These instructions may be used to cause a general-purpose or special-purpose processor that is programmed with the instructions to perform the operations described. Alternatively, the operations may be performed by specific hardware that may contain hardwired logic for performing the operations, or by any combination of programmed computer components and custom hardware components.

The method may be provided as a computer program product that may include a machine-readable medium having stored thereon instructions that may be used to program a computer (or other electronic devices) to perform the method. For the purposes of this specification, the terms “machine-readable medium” may include any medium that is capable of storing or encoding a sequence of instructions for execution by the machine and that cause the machine to perform any one of the methodologies of the present invention. The term “machine-readable medium may accordingly include, but not limited to, solid-state memories, optical and magnetic disks, and a carrier wave that encodes a data signal.

In some embodiments of the present invention, a scalable migration of resources between devices in a wireless personal area network (WPAN) in described. A WPAN scalable migration system, according to some embodiments of the present invention may enable a device to scale the resources it uses as the WPAN changes and to scale the availability of its resources to other devices. The scalable migration system may enable a first device having the scalable migration system to determine whether to permit use of its resources by other devices based on the power availability of the first device. Alternatively or additionally, the system may determine whether the device uses a similar resource on another device instead of its own based on power availability considerations.

Although the scope of the present invention is not limited in this respect, the system and method disclosed herein may be implemented in many wireless, handheld and portable communication devices. By way of example, wireless, handheld and portable communication devices may include wireless and cellular telephones, smart telephones, personal digital assistants (PDAs), web-tablets and any device that may provide wireless access to a network such, an intranet or the internet. It should be understood that the present invention may be used in a variety of applications.

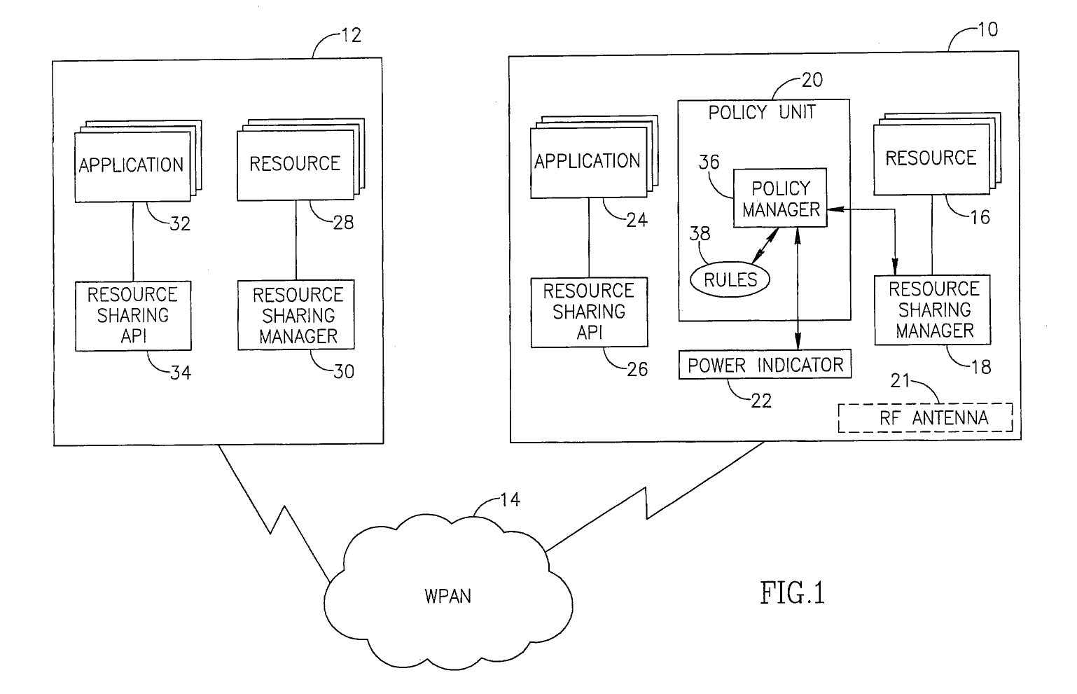

Reference is now made to FIG. 1, which is a simplified block-diagram illustration of a device coupled to a wireless personal area network (WPAN) and having a scalable migration capability according to some embodiments of the present invention. In the exemplary illustration described below, a first device 10 and a second device 12 are both operably coupled to a WPAN 14. Devices 10 and 12 may intercommunicate via wireless communication to transmit, for example, voice, data, video and images.

Although the scope of the present invention is not limited in this respect, the wireless communications technologies may include radio frequency (RF) and infrared. Non-limiting examples of RF wireless standards are protocols, such as, for example, Bluetooth, IEEE-Std 802.11a, IEEE-Std 802.11b, 1999 edition, IEEE-Std 802.11 g and HomeRF. Non-limiting examples of infrared light signals are protocols, such as, for example, InfraRed Data Association (IrDA) standard.

Devices 10 and 12 may communicate with each other over different wireless protocols. Devices 10 and 12 may be, although not limited to, a portable computer, a desktop computer, a wireless telephone, a wired telephone, a mobile telephone, a pager, a digital camera, a scanner, a printer and any other electronic device. In some embodiments, devices coupled to WPAN 14 may include one or more components to enable scaling its resource use.

Device 10 may comprise one or more resources 16 operably coupled to a resource sharing manager 18, a policy unit 20, a power availability indicator 22 and optionally an RP antenna 21. These resources may be shared by other devices over the WPAN 14 via resource sharing manager 18. Non-limiting examples of such resources may include software applications, such as, for example, a notification service, a speech processing service, a time service, a display service, an archiving service and ail export address book entries service. Resources 16 may include hardware resources. Non-limiting examples of hardware resources may include a keyboard, a display and a speaker.

Device 10 may further comprise one or more applications 24 and a resource sharing application program interface (API) 26. Application 24 may be executed by resource 16 of device 10 or may be migrated via resource sharing API 26 and WPAN 14 to be executed by a similar resource of another device. Non-limiting examples of applications may include an Internet browser and a contact list, among many other examples.

Similarly, device 12 may comprise one or more resources 28, each coupled to a resource sharing manager 30 and one or more applications 32 coupled to a resource sharing API 34. Device 12 may also comprise a policy unit (not shown) similar to policy unit 20.

Policy unit 20 may include a policy manager 36 and a rules storage 38 to store one or more policy rules. Storage 38 may be resident in a conventional memory or within a database. Policy manager 36 may apply rules from storage 38 and power availability indications from indicator 22 to determine for example which resources on device 10 may be exposed to applications on other devices such as device 12 for their use. Other rules may be related to conditions for using resources of other devices based on power availability.

Power availability indicator 22 may provide information regarding the present state of several parameters associated with power availability to policy manager 36. Non-limiting examples of such parameters may include indications whether the device uses alternating current (AC) or direct current (DC) produced by battery power, the remaining accumulated energy of the battery and the current power drain.

Policy manager 36 may apply the information from storage 38 and indicator 22 in order to scale its resources upon receiving a notification of the happening of an event from resource sharing manager 18. Non-limiting examples of an event may include connection of a device to WPAN 14, disconnection of a device from WPAN 14 or a change of state of a device already connected to WPAN 14. A state change may occur when a device transitions from running off a battery to running off AC power.

If a resource that the application uses becomes unavailable because of reduced power availability, the application may request to use another similar resource on a different device. Alternatively or additionally, the application may terminate the usage and/or notify the user. The application may also cache operations to the resource. The operations that the user intended to perform may be buffered until the resource becomes available again. The buffered operations may then be executed once the resource becomes available.

Policy manager 36 may also apply the information from storage 38 and indicator 22 based on requests to share resources from other devices. The policy manager 36 may also operate based on queries by other modules of device 10. For example, upon connection of device 10 to WPAN 14, policy manager 36 may determine which resources may be advertised as available to be shared with other devices based on power availability policy rules. In some embodiments, policy manager 36 may determine whether to seamlessly migrate one of applications 28 executing on service 16 of device 10 to be executed by a similar service on device 12 based on power availability considerations.

The policy rules may be accessed and configured through a user interface, from another device or programmatically. Access control to read and/or write policy rules may be restricted. Policy rules associated with exposure of resources to be shared with other devices and power availability may be based on, but not limited to, the following factors:

Whether the device is running off of battery or AC power

How much battery life is left on the device

A power threshold below which the device will not expose the resource for other devices to share

The amount of power being used by the device at present

The resource availability may be restricted based on power availability during the following times:

During resource discovery—The resource may be unavailable based on policy rules.

During resource use—As explained above, based on power availability policy rules, the resource may decide to become unavailable.

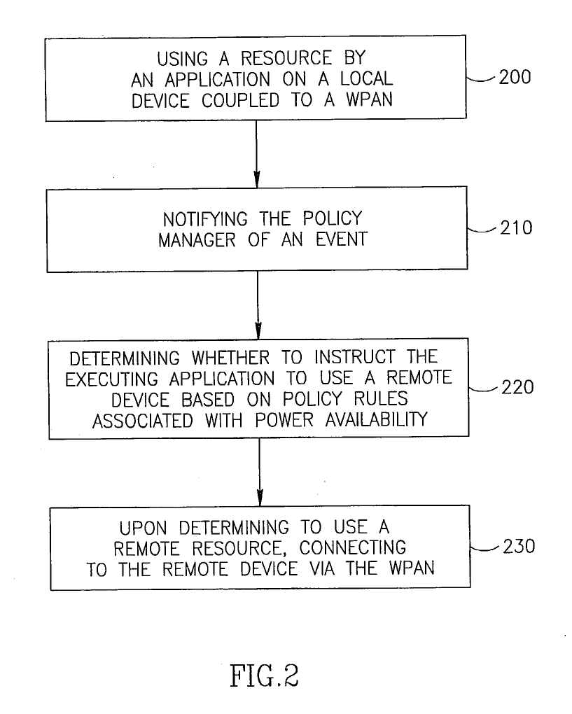

Reference is now made to FIG. 2, which is an exemplary flowchart diagram illustrating a method for using, via a WPAN, resources of a remote device by an application on a local device according to some embodiments of the present invention. At block 200, resource 16 may execute an application 24 on device 10 coupled to WPAN 14. At operation 210, policy manager 36 may be notified of an event, such as the connection of device 12 to WPAN 14.

There are existing standards, such as the Universal Plug and Play (UPnP) protocols that feature an event mechanism that may notify software modules when certain resource related events occur. Devices 10 and 12 may be registered with UPnP protocols to enable the notification of events. If additional information is needed, such as for power availability indicators, a query for such information may be performed. It should be noted that the invention is not limited to using UPnP protocol and device 10 may also make a request directly to device 12, for example via an API call or may accesse other information sources.

The information provided by the event notification or other resources may include information regarding the power availability of device 12, for example, whether device 12 is running off of battery or AC power. At operation 220, upon receiving the information regarding device 12, policy manager 36 may request information regarding the power availability of device 10 from indicator 22. Based on the policy rules and the received data, policy manager may determine whether to instruct the executing application to use a remote resource, such as resource 28 of device 12.

Alternatively, according to other embodiments of the present invention, the executing application 24 may receive the notification information and the indicator information and may access the appropriate policy rule to determine whether to use a resource on device 12. Either the policy manager 36 or application 24 may determine whether to use a remote resource based on notification information, power availability information and associated policy rules. At operation 230, upon determining to use a remote resource of device 12, a communications connection between device 10 and device 12 may be generated and the resource use may be transitioned. For example, device 10 may be running off of battery and device 12 may be running of AC power. For these conditions, the appropriate policy rule may direct policy manager 16 to instinct device 10 to use a remote resource 28 for application 24.

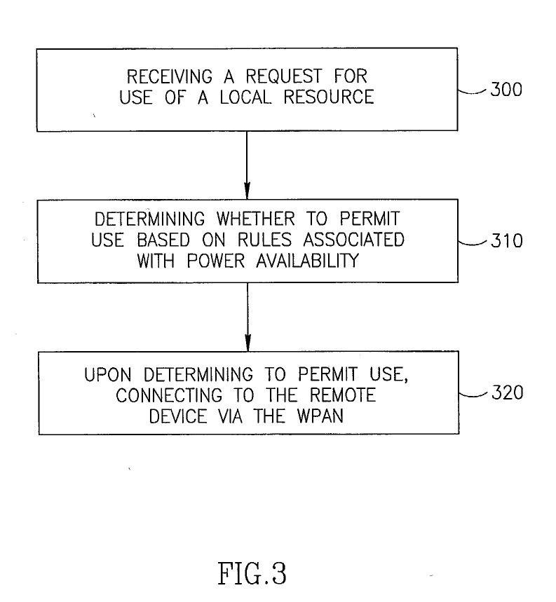

Reference is now made to FIG. 3, which is a flowchart diagram of a method for managing use of local resources via a WPAN by other devices according to some embodiments of the present invention. At operation 300, policy manager 36 of device 10 may be notified of a request by application 32 of device 12 to use resource 16 of device 10. Device 10 then may process the request to determine whether to permit application 36 of device 12 to use resource 16 based policy rules associated with power availability and power availability information (operation 310). If the request is accepted, a connection with device 12 via WPAN 14 may be generated and resource 16 may execute application 32 (operation 320).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
determining whether to permit use of a local resource by a remote device via a wireless personal area network based on policy rules associated with power availability of a local device comprising said local resource.

2. The method of claim 1, further comprising:
receiving via said wireless personal area network a request from said remote device for the use of said local resource.

3. The method of claim 1, further comprising:
determining whether to advertise over said wireless personal area network that said local resource is available for resource sharing based on said policy rules.

4. The method of claim 1, wherein determining whether to permit said use is based on a present state of power availability parameters.

5. A method comprising:
determining whether to use a remote resource of a remote device via a wireless personal area network based on policy rules associated with power availability of a local device.

6. The method of claim 5 further comprising:
prior to determining whether to use said remote source, detecting via said wireless personal area network an event associated with said remote device.

7. The method of claim 6, wherein detecting said event comprises:
receiving a notification from said remote device, the notification including device information regarding power availability of the remote device.

8. The method of claim 5 further comprising:
requesting information regarding power availability of said remote device.

9. An apparatus comprising:
a resource executable on the apparatus; and
a policy manager to determine whether to permit use of the resource by a remote device via a wireless personal area network based on policy rules associated with power availability of the apparatus.

10. The apparatus of claim 9 wherein said policy manager is further able to determine whether to use a remote resource of the remote device via the wireless personal area network based on said policy rules.

11. The apparatus of claim 9 further comprising:
a power availability indicator to provide power availability data to said policy manager.

12. An apparatus comprising:
a radio frequency antenna to receive signals over a wireless personal area network;
a resource executable on the apparatus; and
a policy manager to determine whether to permit use of the resource by a remote device via said wireless personal area network based on policy rules associated with power availability of the apparatus.

13. The apparatus of claim 12 wherein said policy manager is further able to determine whether to use a remote resource of the remote device via the wireless personal area network based on said policy rules.

14. The apparatus of claim 13 further comprising:
a power availability indicator to provide power availability data to said policy manager.

15. An article comprising a storage medium having stored thereon instructions that, when executed by a processing platform, result in:
determining whether to permit use of a local resource by a remote device via a wireless personal area network based on policy rules associated with power availability of a local device comprising said local resource.

16. The article of claim 15, wherein the instructions when executed further result in:
determining whether to use a remote resource of said remote device or another remote device via said wireless personal area network based on policy rules associated with power availability of said local device.

17. The article of claim 15, wherein the instructions when executed further result in:
determining whether to advertise over said wireless personal area network that said local resource is available for resource sharing based on said policy rules.

18. A system comprising:
a remote device coupled to a wireless personal area network;
a local device coupled to said wireless personal area network and having a policy manager to determine whether to permit use of a local resource by said remote device based on policy rules associated with power availability of said local device.

19. The system of claim 18, wherein said policy manager is further able to determine whether to use a remote resource of the remote device via the wireless personal area network based on said policy rules.

20. The system of claim 18 further comprising:
a power availability indicator to provide power availability data to said policy manager.
